(19) United States
(12) Patent Application Publication
(10) Pub. No.: US 2019/0370422 A1
(43) Pub. Date: Dec. 5, 2019

(54) METHOD AND SYSTEM FOR SIMULATING DEFORMATION OF A THIN-SHELL MATERIAL

(71) Applicant: Ziva Dynamics Inc., Vancouver (CA)

(72) Inventor: Essex Edwards, Vancouver (CA)

(21) Appl. No.: 16/432,794

(22) Filed: Jun. 5, 2019

Related U.S. Application Data
(60) Provisional application No. 62/680,825, filed on Jun. 5, 2018.

(51) Int. Cl. G06F 17/50

(52) U.S. Cl. CPC G06F 17/5009; G06F 2217/32; G06F 2217/16

(57) ABSTRACT

Methods, systems, and techniques for simulating deformation of a thin-shell material. A processor is used to obtain a mesh of the material, which is made up of polygons and hinges and in which any two of the polygons that are adjacent to each other connect to each other at one of the hinges. The processor then determines forces affecting vertices of the mesh. The forces are determined from a gradient of cumulative potential energy which, for each of at least some of the hinges, includes a discretized bending energy that has a finite lower bound and that is determined using a difference between a current curvature vector and a reference curvature vector. The processor then simulates deformation of the mesh using those forces.

### CROSS-REFERENCE TO RELATED APPLICATION

This application claims priority to U.S. provisional patent application No. 62/680,825, filed on Jun. 5, 2018, and entitled “Method and System for Simulating Deformation of a Thin-Shell Material”, the entirety of which is hereby incorporated by reference herein.

### TECHNICAL FIELD

The present disclosure is directed at methods, systems, and techniques for simulating deformation of a thin-shell material.

### BACKGROUND

When performing computer simulated deformation of a thin-shell material such as cloth, a common practice is to model the potential energy of the cloth as the sum of an in-plane model and a bending model. There are a variety of different bending models conventionally used in computer simulation, which reflect a variety of design choices and trade-offs relevant to considerations such as the model's computational performance, accuracy, stability, and invariance to the type of mesh used to represent the thin-shell material.

### SUMMARY

According to a first aspect, there is provided a method for simulating deformation of a thin-shell material, the method comprising using a processor to: obtain a mesh of the material, wherein the mesh comprises polygons and hinges and wherein any two of the polygons that are adjacent to each other connect to each other at one of the hinges; determine forces affecting vertices of the mesh, wherein the forces comprise a gradient of cumulative potential energy comprising, for each of at least some of the hinges, a discretized bending energy that has a finite lower bound and that is determined using a difference between a current curvature vector and a reference curvature vector; and simulate deformation of the mesh using the forces affecting the vertices of the mesh.

Each of the current and reference curvature vectors may vary quadratically with position of the vertices.

The deformation may be substantially isometric. Alternatively, the deformation may not be substantially isometric.

The discretized bending energy may be determined from an even power of the difference between the current curvature vector and the reference curvature vector. For example, the discretized bending energy may be determined from a square of the difference between the current curvature vector and the reference curvature vector.

The reference curvature vector may comprise a reference curvature multiplied by a hinge normal vector. The hinge normal vector may comprise a weighted average of a first normal vector of a first polygon on one side of the hinge and a second normal vector of a second polygon defining on another side of the hinge.

The polygons may be triangles, and using the processor to determine the first normal may comprise determining a cross product of vectors corresponding to the hinge and another side of the first polygon, and using the processor to determine the second normal may comprise determining a cross product of vectors corresponding to the hinge and another side of the second polygon, when the other sides of the first and second polygons share a vertex.

The first normal vector may be weighted by a first weight that varies inversely to an area of the first polygon, and the second normal vector may be weighted by a second weight that varies inversely to an area of the second polygon.

The first normal vector may be weighted by a first weight comprising

$$\frac{1}{{A}_{0} ‖ \frac{{n}_{0}}{{A}_{0}} + \frac{{n}_{1}}{{A}_{1}} ‖} ,$$

and the second normal vector may be weighted by a second weight comprising

$$\frac{1}{{A}_{1} ‖ \frac{{n}_{0}}{{A}_{0}} + \frac{{n}_{1}}{{A}_{1}} ‖} ,$$

in which A₀ is an area of the first polygon, A₁ is an area of the second polygon, n₀ is the first normal, and n₁ is the second normal.

Each of the first and second weights may be fixed at a value representing the first and second polygons when the mesh is in a rest configuration.

The rest configuration may be selected such that no hinge angle of any of the at least some of the hinges is 180 degrees.

The hinge normal may be determined as a⊗b, in which a=Xf, b=Xg,

$$X = [ \begin{matrix}{x}_{0} & {x}_{1} & {x}_{2} & {x}_{3} \\ {x}_{0} & {x}_{1} & {x}_{2} & {x}_{3} \\ {x}_{0} & {x}_{1} & {x}_{2} & {x}_{3}\end{matrix} ] , f = [ \begin{matrix}- 1 \\ 1 \\ 0 \\ 0\end{matrix} ] , and g = [ \begin{matrix}{w}_{1} - {w}_{0} \\ 0 \\ {w}_{0} \\ - {w}_{1}\end{matrix} ] ,$$

in which x₀, x₁, and x₂ are the vertices of the first polygon; x₀, x₁, and x₃ are the vertices the second polygon; w₀ is the first weight; and w₁ is the second weight.

The reference curvature vector may be determined as a⊗b, wherein a=

$$Xf , b = Xg , X = [ \begin{matrix}{x}_{0} & {x}_{1} & {x}_{2} & {x}_{3} \\ {x}_{0} & {x}_{1} & {x}_{2} & {x}_{3} \\ {x}_{0} & {x}_{1} & {x}_{2} & {x}_{3}\end{matrix} ] ,$$

and either:

$$f = [ \begin{matrix}- 1 \\ 1 \\ 0 \\ 0\end{matrix} ] and g = [ \begin{matrix}\overline{H} \cdot ( {w}_{1} - {w}_{0} ) \\ 0 \\ \overline{H} \cdot {w}_{0} \\ - \overline{H} \cdot {w}_{1}\end{matrix} ] , or$$

$$f = [ \begin{matrix}- \overline{H} \\ \overline{H} \\ 0 \\ 0\end{matrix} ] and g = [ \begin{matrix}( {w}_{1} - {w}_{0} ) \\ 0 \\ {w}_{0} \\ - {w}_{1}\end{matrix} ] ,$$

in which x₀, x₁, and x₂ are the vertices of the first polygon; x₀, x₁, and x₃ are the vertices of the second polygon; w₀ is the first weight; w₁ is the second weight; and H̅ is the reference curvature.

The current curvature vector may be determined as Xl, wherein l is a 4×1 element Laplacian matrix determined using cotangent weights of the mesh in the rest configuration.

The current curvature vector may be a current mean curvature vector, and the reference curvature vector may be a reference mean curvature vector.

The current curvature vector and the reference curvature vector may be selected from the group consisting of mean curvature, anisotropic mean curvature, Gaussian curvature, maximum curvature, and minimum curvature.

The method may further comprise using the processor to animate, on a display, the deformation of the mesh using results of simulating the deformation.

According to another aspect, there is provided a system for simulating deformation of a thin-shell material, the system comprising: a display; an input device; a processor communicatively coupled to the display and input device; and a memory communicatively coupled to the processor, the memory having stored thereon computer program code, executable by the processor, which when executed by the processor causes the processor to perform the method of any of the above-recited aspects or suitable combinations thereof.

According to another aspect, there is provided a non-transitory computer readable medium having stored thereon computer program code, executable by a processor, which when executed by the processor causes the processor to perform the method of any of the above-recited aspects or suitable combinations thereof.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts two triangles comprising a triangle mesh of a thin-shell material, and a hinge that connects two edges of the triangles.

FIG. 2 depicts a method for simulating deformation of a thin-shell material, according to an example embodiment.

FIG. 3A depicts a thin-shell in the form of a cloth suspended over a sphere.

FIGS. 3B and 3C depict the cloth of FIG. 3A deforming over the sphere of FIG. 3A in accordance with example embodiments, in which the cloth has a first bending stiffness coefficient (FIG. 3B) and a second bending stiffness coefficient that is higher than the first bending stiffness coefficient (FIG. 3C).

FIGS. 4A-4E depict screenshots at various times during deformation of a thin-shell material, according to the prior art.

FIGS. 5A-5E depict screenshots at times, corresponding to those of FIGS. 4A-4E, during deformation of a thin-shell material according to an example embodiment.

FIG. 6 depicts a system for simulating deformation of a thin-shell material, according to another embodiment.

### DETAILED DESCRIPTION

A “thin-shell” material in the context of computer-aided simulation refers to a material having a thickness small enough relative to its length and width that a computer processor can, for practical purposes, ignore that thickness while simulating its deformation. In at least some example embodiments, a thin-shell material has a thickness of no more than 1% of one or both of its width and length.

A processor may model a thin-shell material as a mesh comprising a number of polygons and hinges. Any two of the polygons that are adjacent to each other connect to each other at one of the hinges, with the angle the two polygons make at the hinge being the “hinge angle”. Common types of meshes comprise triangle meshes and quadrilateral meshes. When using a processor to simulate the deformation of a mesh modeling a thin-shell material, the processor determines forces affecting vertices of the mesh. The processor may do this at least in part by determining a gradient of the cumulative potential energy of the mesh. That cumulative potential energy typically comprises the sum of multiple different types of energies relative to when the mesh is in its “rest configuration”, where the “rest configuration” is defined as the mesh's configuration when it is not deformed. For example, the processor may determine the stretch/shear energy, gravitational potential energy, and the bending energy of the mesh, with the stretch/shear energy referring to the potential energy of the mesh resulting from stretching/shearing relative to the mesh's rest configuration, and the bending energy referring to the potential energy of the mesh resulting from changes in hinge angle relative to the mesh's rest configuration.

One conventional way to determine a mesh's bending energy is referred to as “Cubic Shells” and is described in Akash Garg, Eitan Grinspun, Max Wardetzky, and Denis Zorin, “Cubic Shells”, Proceedings of the 2007 ACM SIGGRAPH/Eurographics Symposium on Computer Animation, SCA '07, pp. 91-98, Aire-la-Ville, Switzerland, 2007, Eurographics Association. However, a processor applying Cubic Shells determines bending energy by evaluating a cubic polynomial, which permits certain mesh deformations to result in instability that causes the bending energy to approach negative infinity. This causes the computer-aided simulation of the mesh's deformation to fail.

In some other conventional methods for determining bending energy, a processor evaluates bending energy as a function of the hinge angle. During certain deformations, this causes the processor to suffer from “altitude collapse” in which the processor determines the derivative of the hinge angle with respect to mesh vertex position as approaching infinity. For example, in the context of a triangle mesh in which two vertices of a triangle comprise part of the hinge, a deformation that causes the third vertex of that triangle to approach the hinge may result in altitude collapse, which causes the computer-aided simulation of the mesh's deformation to fail.

Certain other conventional methods for determining bending energy are referred to as mass-spring systems, which apply “bending-springs” to determine bending energy for cloth. While those systems do not suffer from altitude collapse or the instability of Cubic Shells, they are not particularly accurate. They also do not offer mesh independence; i.e., the bending energy determined by using bending-springs may vary with the type of mesh used to model the thin-shell material.

In at least some example embodiments described herein, a processor simulates deformation of a thin-shell material. The processor obtains a mesh of the material, which comprises polygons and hinges and in which any two of the polygons that are adjacent to each other connect to each other at one of the hinges. The processor then determines a cumulative potential energy of the vertices of the mesh. The cumulative potential energy comprises, for each of at least some of the hinges, a discretized bending energy that has a finite lower bound and that is determined using a difference between a current mean curvature vector and a reference mean curvature vector. As the bending energy has a finite lower bound, these example embodiments do not suffer from Cubic Shells' instability problem. The processor subsequently determines, from the cumulative potential energy, a force affecting the vertices of the mesh and simulates deformation of the mesh using that force. This results in a method that is more accurate than the mass-springs systems' method described above and that is substantially mesh independent. Further, it does not express the bending energy as a function of bending angle and accordingly does not suffer from altitude collapse.

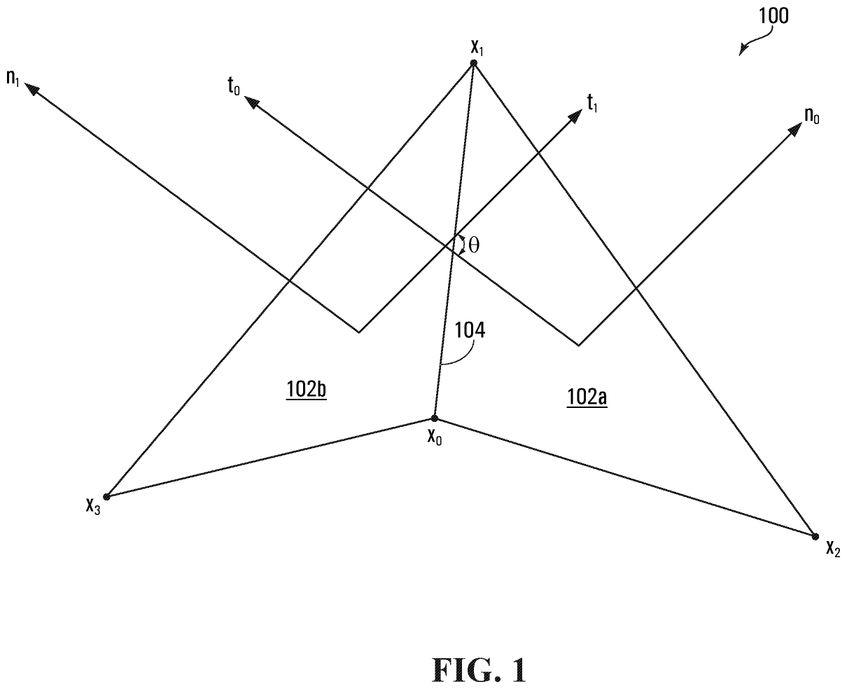

Referring now to FIG. 1, there are depicted a first triangle 102a and a second triangle 102b comprising a triangle mesh 100 of a thin-shell material, and a hinge that connects two edges of the triangles 102a,b. The mesh 100 may be deformed in accordance with at least some example embodiments. While a triangle mesh is used in the following description, in at least some different embodiments the mesh 100 may comprise a different type of polygons, such as quadrilaterals.

The first triangle 102a is defined by the vertices x₀, x₁, and x₂, while the second triangle 102b is defined by the vertices x₀, x₁, and x₃. Vertices x₀ and x₁ are shared by the triangles 102a,b and accordingly define a hinge 104 that is common to the triangles 102a,b. The first triangle 102a has a normal vector n₀ and a tangent vector t₀, and the second triangle 102b has a normal vector n₁ and a tangent vector t₁. The areas of the first and second triangles 102a,b are A₀ and A₁, respectively. The angle labeled θ in FIG. 1 is the hinge angle (i.e., the angle between the two tangent vectors t₀ and t₁), and is zero when the triangles 102a,b lay flat (i.e., when they collectively form a plane). A hinge normal vector is n as discussed further below, H is the mean curvature at the hinge 104, and the mean curvature vector is accordingly h=Hn.

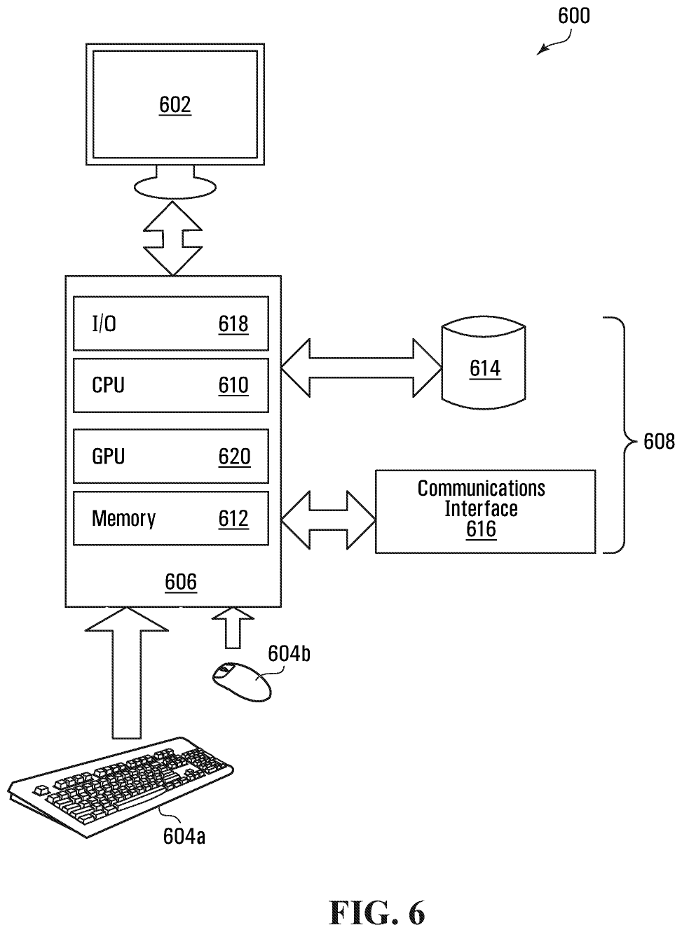

A processor 610 (depicted only in FIG. 6) is used to determine a discretized bending energy of the triangle mesh 100, as described below. The discretized bending energy is derived from a continuum model of the bending energy, given by Equation (1):

E=½∫_{S}(H−H̅)²dA (1)

where H̅ is a reference mean curvature as described further below, and H is the mean curvature at the time the processor 610 evaluates Equation (1) (H is hereinafter interchangeably referred to as a “current mean curvature”).

The continuum energy given by Equation (1) may in at least some other example embodiments also comprise a spatially varying stiffness coefficient, although one is not shown in the version of Equation (1) above. Introducing the mean curvature vector to Equation (1) results in Equation (2):

E=½∫_{S}∥h−H̅n∥²dA (2)

where h is a current mean curvature vector, and H̅n is a reference mean curvature vector.

To discretize Equation (2), h and n are approximated on each hinge 104 of the mesh 100. X is defined as a 3×4 matrix from concatenating xᵢ together (i.e.,

$$X = [ \begin{matrix}{x}_{0} & {x}_{1} & {x}_{2} & {x}_{3} \\ {x}_{0} & {x}_{1} & {x}_{2} & {x}_{3} \\ {x}_{0} & {x}_{1} & {x}_{2} & {x}_{3}\end{matrix} ] ) ,$$

and h is defined as Xl, where l is the element Laplacian 4×1 matrix made from the cotangent weights of the mesh 100 when in the rest configuration.

The normals of the triangles 102a,b n₀ and n₁ are combined to determine the hinge normal n. The first triangle's 102a normal vector n₀ is defined to equal (x₂−x₀) ⊗(x₁−x₀) and the second triangle's 102b normal vector n₁ is defined to equal−(x₃−x₀)⊗(x₁−x₀). The first triangle's 102a normal vector n₀ is accordingly a cross product of vectors corresponding to the hinge 104 and another side of the first triangle 102a, and the second triangle's 102b normal vector n₁ is accordingly a cross product of vectors corresponding to the hinge 104 and another side of the second triangle 102b, with those other sides of the triangles 102a,b used to determine the cross products sharing a vertex (x₀ in this example). As each of the normal vectors n₀ and n₁ are determined as the cross product of vectors corresponding to the triangles' 102a,b edges, the normal vectors n₀ and n₁ vary quadratically with position of the triangles' 102a,b vertices. The current and reference mean curvature vectors accordingly also vary quadratically with position of the triangles' 102a,b vertices. Treating the normal vectors n₀ and n₁ as quadratic in this way is only mathematically correct for isometric deformations; notwithstanding this, through experimentation it has been determined the embodiments described herein are applicable to deformations regardless of whether they are substantially isometric, where deformation is “substantially” isometric in at least some example embodiments if stretching of the mesh 100 is no greater than 15% during simulation.

A generalized expression of the hinge normal n′ is then as follows:

$$\begin{matrix}{n}^{′} = ( \frac{{n}_{0}}{{A}_{0}} + \frac{{n}_{1}}{{A}_{1}} ) / ‖ \frac{{n}_{0}}{{A}_{0}} + \frac{{n}_{1}}{{A}_{1}} ‖ & ( 3 ) \\ = \frac{{n}_{0}}{{A}_{0} ‖ \frac{{n}_{0}}{{A}_{0}} + \frac{{n}_{1}}{{A}_{1}} ‖} + \frac{{n}_{1}}{{A}_{1} ‖ \frac{{n}_{0}}{{A}_{0}} + \frac{{n}_{1}}{{A}_{1}} ‖} & ( 4 ) \\ = {w}_{0}^{′} {n}_{0} + {w}_{1}^{′} {n}_{1} & ( 5 )\end{matrix}$$

During simulation, the values of w₀′, and w₁′ may vary. For example, the first weight w₀′ may vary inversely to an area of the first triangle 102a, and the second weight w₁′ may vary inversely to an area of the second triangle 102b. In order to make simulation computationally more efficient and to avoid altitude collapse, in at least some example embodiments the values of w₀′ and w₁′ are fixed to what they are when the mesh 100 is in its rest configuration. In at least some different example embodiments, they may be fixed to values other than those when the mesh 100 is in the rest configuration. Using the mesh's 100 rest configuration to fix w₀′ and w₁′ may be beneficial in that the rest configuration then has the lowest potential energy, and consequently during simulation the mesh 100 is driven towards the rest configuration.

The value of w₀′ when the mesh 100 is in the rest configuration is w₀, and the value of w₁′ when the mesh 100 is in the rest configuration is w₁. The hinge normal n is accordingly as follows:

n=w₀n₀+w₁n₁ (6)

The hinge normal vector n accordingly comprises a weighted average of the first normal vector n₀ of the first triangle 102a on one side of the hinge 104 and the second normal vector n₁ of the second triangle 102b on another side of the hinge 104.

As the hinge angle in the rest configuration goes to 180 degrees, which represents the mesh 100 being completely folded over itself at rest, the weights w₀ and w₁ go to infinity. Accordingly, in at least some example embodiments, the rest configuration is selected such that no hinge angle is 180 degrees. For example, the denominators of w₀′ and w₁′ may fixed to be no smaller than if the hinge angle were 179 degrees.

The hinge normal vector n may be written as a single cross product:

n=w₀n₀+w₁n₁=a⊗b (7)

where

$$a = Xf , b = Xg , f = [ \begin{matrix}- 1 \\ 1 \\ 0 \\ 0\end{matrix} ] , and g = [ \begin{matrix}{w}_{1} - {w}_{0} \\ 0 \\ {w}_{0} \\ - {w}_{1}\end{matrix} ] .$$

In at least some example embodiments, H̅ may be pre-multiplied into g or f such that H̅n=a⊗b, in which case the discrete energy for the hinge 104 is as follows:

Eₕ=c∥h−H̅n∥₂² (8)

=c∥Xl−(Xf)⊗(Xg)∥₂² (9)

for a constant c that collects together constants such as triangle area, which is treated as constant in example embodiments in which the weights w₀′ and w₁′ are fixed to their values when the mesh 100 is in the rest configuration, and stiffness coefficient. As is evident from Equations (8) and (9), the discretized bending energy is determined from an even power, and in the case of Equations (8) and (9) the square, of the difference between the current mean curvature vector and the reference mean curvature vector. This ensures the bending energy has a finite lower bound, in contrast to Cubic Shells.

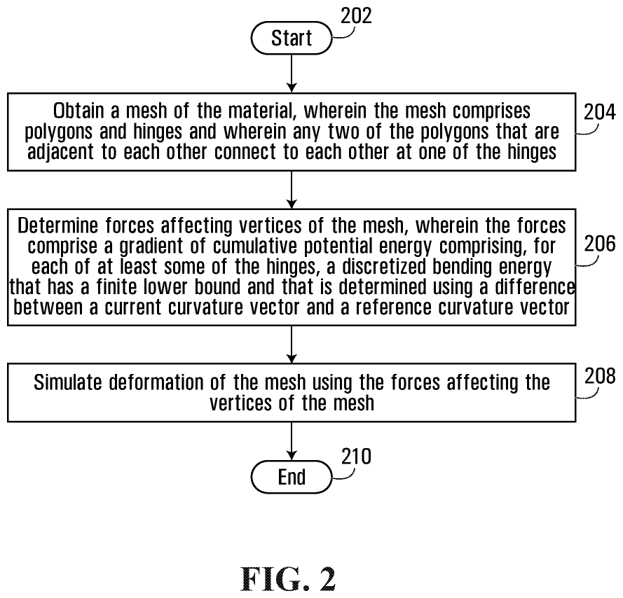

Referring now to FIG. 2, there is depicted a computer-implemented method 200 for simulating deformation of a thin-shell material, according to an example embodiment. In at least some example embodiments, the method 200 may be applied using a computer system 600 that comprises the processor 610 as depicted in FIG. 6.

The computer system 600 comprises a display 602; input devices in the form of keyboard 604a and pointing device 604b; computer 606; and external devices 608. While the pointing device 604b is depicted as a mouse, other types of pointing devices may also be used. In alternative embodiments (not depicted), the computer system 600 may not comprise all the components depicted in FIG. 6.

The computer 606 may comprise one or more processors or microprocessors, such as the processor (central processing unit, or “CPU”) 610, which is depicted. The processor 610 performs arithmetic calculations and control functions to execute software stored in an internal memory 612, such as one or both of random access memory (“RAM”) and read only memory (“ROM”), and possibly additional memory 614. The additional memory 614 may comprise, for example, mass memory storage, hard disk drives, optical disk drives (including CD and DVD drives), magnetic disk drives, magnetic tape drives (including LTO, DLT, DAT and DCC), flash drives, removable memory chips such as EPROM or PROM, emerging storage media, such as holographic storage, or similar storage media as known in the art. This additional memory 614 may be physically internal to the computer 606, external as shown in FIG. 6, or both. The method 200 of FIG. 2 may be expressed as computer program code and stored in, for example, one or both of the internal memory 612 and the additional memory 614. The code may be executable by the processor 610 and, when executed, cause the processor 610 to perform the method 200.

The computer system 600 may also comprise other similar means for allowing computer programs or other instructions to be loaded. Such means can comprise, for example, a communications interface 616 that allows software and data to be transferred between the computer system 600 and external systems and networks. Examples of the communications interface 616 comprise a modem, a network interface such as an Ethernet card, a wireless communication interface, or a serial or parallel communications port. Software and data transferred via the communications interface 616 are in the form of signals which can be electronic, acoustic, electromagnetic, optical, or other signals capable of being received by the communications interface 616. Multiple interfaces can be provided on the computer system 600.

Input to and output from the computer 606 is administered by the input/output (I/O) interface 618. The I/O interface 618 administers control of the display 602, keyboard 604a, external devices 608, and other analogous components of the computer system 600. The computer 606 also comprises a graphical processing unit (“GPU”) 620. The GPU 620 may also be used for computational purposes as an adjunct to, or instead of, the processor 610, for mathematical calculations. However, as mentioned above, in alternative embodiments (not depicted) the computer system 600 need not comprise all of these elements.

The various components of the computer system 600 are coupled to one another either directly or indirectly by shared coupling to one or more suitable buses.

The processor 610 begins performing the method 200 at block 202 and proceeds to block 204. At block 204, the processor 610 obtains the mesh 100 of the material. The mesh 100 may be stored, for example, in the additional memory 614. The mesh 100 comprises polygons, such as the triangles 102a,b, and hinges 104. As discussed above in respect of FIG. 1, any two of the polygons that are adjacent to each other connect to each other at one of the hinges 104.

After obtaining the mesh 100 at block 204, the processor 610 proceeds to block 206 and determines forces affecting the vertices of the mesh 100. As mentioned above, the forces comprise a gradient of the cumulative potential energy, and the cumulative potential energy comprises, for each of at least some of the hinges 104, a discretized bending energy that has a finite lower bound and that is determined using a difference between the current mean curvature vector and the reference mean curvature vector. The processor 610 may, for example, evaluate the discretized bending energy of the mesh 100 at any given time by evaluating Equation (9), above, for all of the at least some of the hinges 104. The processor 610 may add the bending energy to another energy, such as the shear energy, to determine the cumulative potential energy of the vertices of the mesh 100. Determining the force may be done, for example, using any suitable numerical ordinary differential equation integration method for stepping through time to determine the force applied to the vertices at different times. These comprise any suitable backward Euler time integration method; forward Euler time integration method; Verlet method; velocity Verlet method; Leapfrog method; implicit Newmark method; multistep methods, such as the Backwards Difference Family of integrators; any of the Runge-Kutta family of integrators, implicit or explicit, such as the RK4 integrator; and exponential integrators.

After block 206, the processor 610 proceeds to block 208 and simulates deformation of the mesh 100 using the forces affecting the vertices of the mesh 100 using knowledge the processor 610 has about the mesh 100 such as the masses of the vertices. This may be done using software such as the Maya™ software by Autodesk Inc. The processor 610 may store the results of the simulation in any suitable memory, such as the additional memory 614. In practice, H̅ is often small; for example, H̅ may be zero for non-seam portions of clothing. When this is the case, the Hessian of the bending energy is nearly constant, which beneficially facilitates the processor's 610 simulation. After block 208, the method 200 ends at block 210.

In at least some example embodiments, the processor 610 may animate, on the display 602, the deformation of the mesh 100 using the results of simulating the deformation.

The processor performs blocks 206 and 208 repeatedly as the mesh's 100 deformation progresses. For each time step at which the mesh's 100 shape changes (i.e., as deformation progresses), the processor 610 performs block 206 again to determine the forces affecting the mesh's 100 vertices at that time step, and then performs block 208 again to simulate the mesh's 100 deformation resulting from those forces.

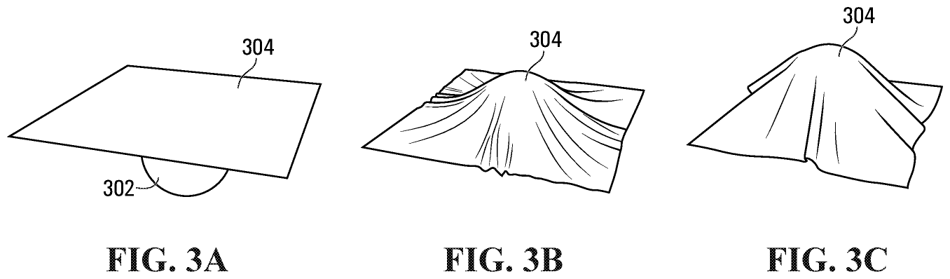

Referring now to FIGS. 3A-3C, there is shown an example of the processor 610 applying the method 200 to simulate deformation of a cloth 304 over a sphere 302, in accordance with two example embodiments. In FIGS. 3A-3C, the cloth 304 is a thin-shell material that the processor 610 models as a mesh 100 of triangles. In FIG. 3A, the cloth 304 is not deformed (i.e., is depicted in its rest configuration, which in FIG. 3A is flat) and is suspended over the sphere 302. FIGS. 3B and 3C depict the cloth 304 after its deformation over the sphere 302 has been simulated by the processor 610 in accordance with the method 200 of FIG. 2. The cloth 304 of FIG. 3B has a first bending stiffness coefficient and in FIG. 3C has a second bending stiffness coefficient that is higher than the first bending stiffness coefficient. As mentioned above, the bending stiffness coefficient affects the value of c in Equation (9).

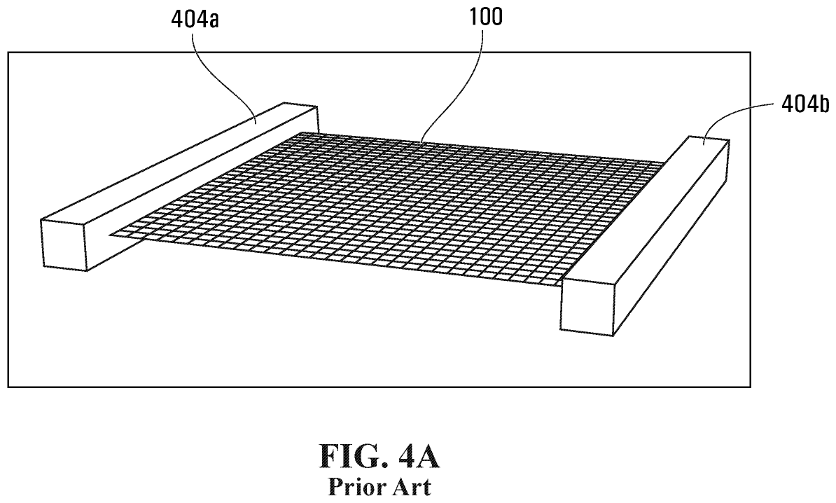

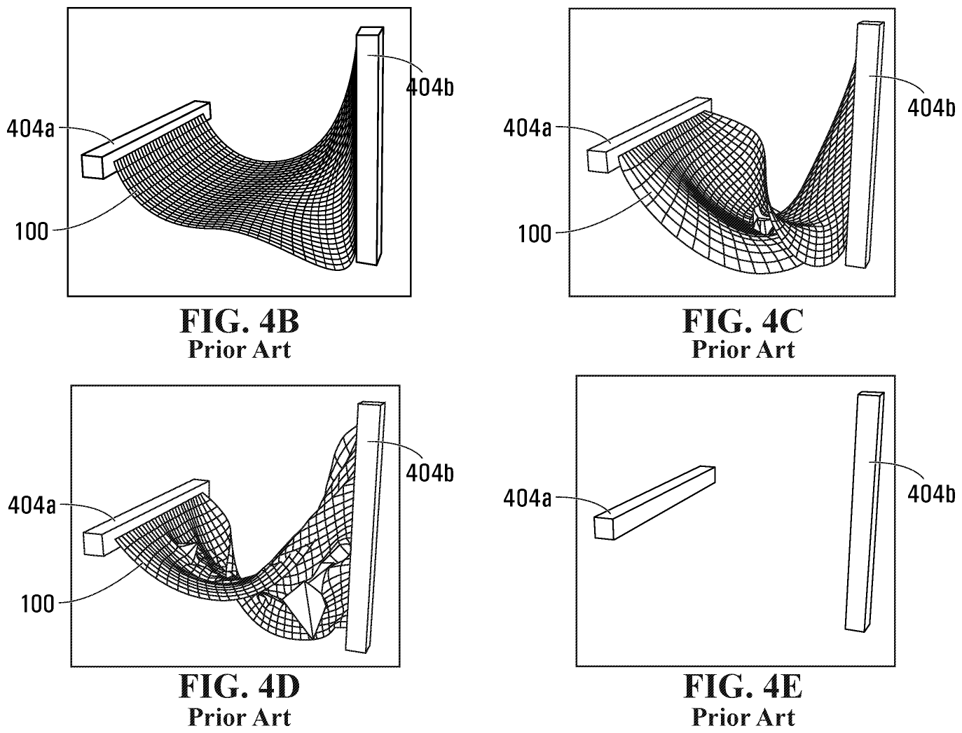

Referring now to FIGS. 4A-4E, there are depicted screenshots at various times during deformation of a thin-shell material, according to the prior art. The method applied to generate FIGS. 4A-4E is described in David Baraff and Andrew Witkin, 1998, “Large Steps in Cloth Simulation”, Proceedings of the 25th Annual Conference on Computer Graphics and Interactive Techniques (SIGGRAPH '98), ACM, New York, N.Y., USA, pp. 43-54. Each of FIGS. 4A-4E shows an example triangle mesh 100 attached to a pair of supports 402a,b, with each figure representing a different frame captured at a different time of the deformation simulation and with deformation increasing with frame count. FIG. 4A depicts the simulation at frame 1 (i.e., no deformation yet, with the mesh 100 shown in its rest configuration); and FIGS. 4B, 4C, 4D, and 4E depict the simulation at frames 9, 20, 52, and 55, respectively. FIGS. 4A-4E show that the simulation worsens with increasing frame count as a result of altitude collapse.

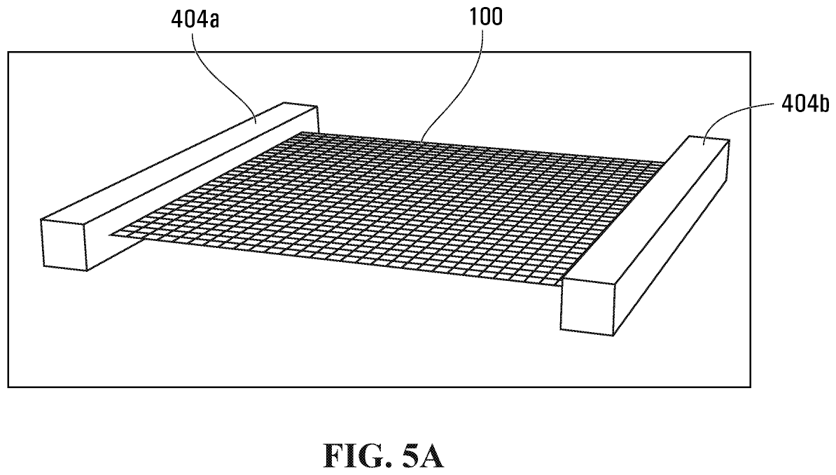

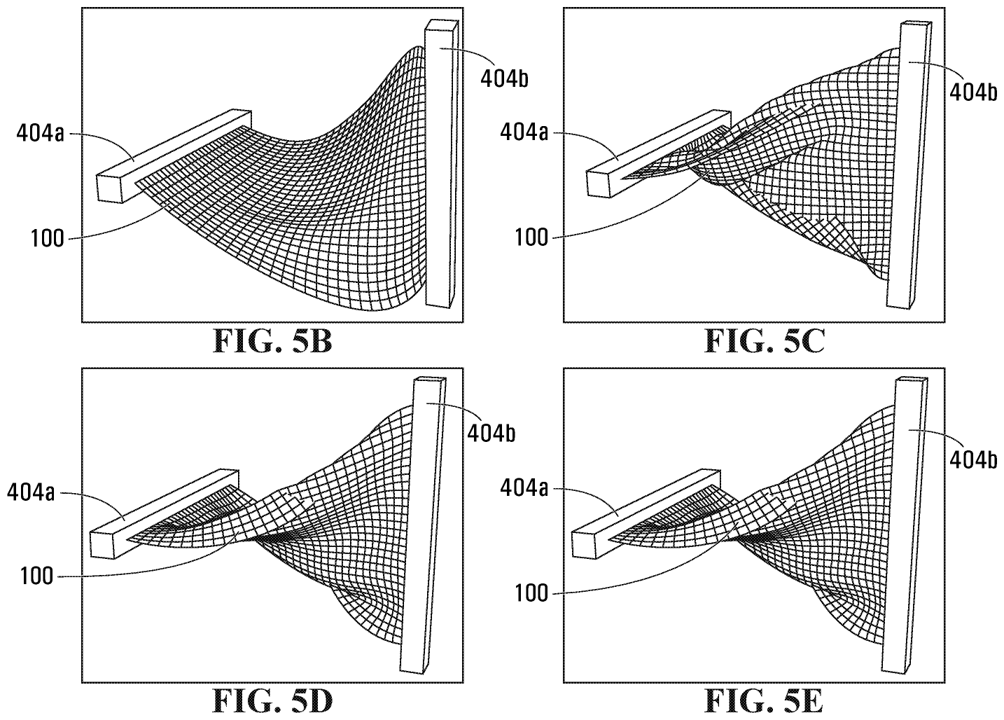

FIGS. 5A-5E, in contrast, depict screenshots at various times during deformation of the same mesh 100 according to an example embodiment. FIG. 5A again depicts the simulation at frame 1 with no deformation, and FIGS. 5B, 5C, 5D, 5E again depict the simulation at frames 9, 20, 52, and 55. In sharp contrast to FIGS. 4A-4E, the simulation remains stable even at frame 55.

While in the example embodiments of FIGS. 3A-3C, 4A-4E, and 5A-5E the thin-shell material is in the form of a cloth, in at least some other example embodiments the thin-shell material may take another form. For example, the surface of a volumetric material (i.e., a material that is not a thin-shell material) may be treated as a thin-shell, and a processor may deform that surface in accordance with the example embodiments described herein.

The above-described example embodiments use mean curvature for the current and reference curvatures. However, in at least some different example embodiments (not depicted), a different type of curvature may be used as the current and mean curvatures. For example, the current and reference curvatures may comprise anisotropic mean curvature, Gaussian curvature, maximum curvature, or minimum curvature.

The embodiments have been described above with reference to flowcharts and block diagrams of methods, apparatuses, systems, and computer program products. In this regard, the flowchart of FIG. 2 and the block diagram of FIG. 6 illustrate the architecture, functionality, and operation of implementations of various embodiments. For instance, each block of the flowcharts and block diagrams may represent a module, segment, or portion of code, which comprises one or more executable instructions for implementing the specified action(s). In some alternative embodiments, the action(s) noted in that block may occur out of the order noted in those figures. For example, two blocks shown in succession may, in some embodiments, be executed substantially concurrently, or the blocks may sometimes be executed in the reverse order, depending upon the functionality involved. Some specific examples of the foregoing have been noted above but those noted examples are not necessarily the only examples. Each block of the block diagrams and flowcharts, and combinations of those blocks, may be implemented by special purpose hardware-based systems that perform the specified functions or acts, or combinations of special purpose hardware and computer instructions.

Each block of the flowcharts and block diagrams and combinations thereof can be implemented by computer program instructions. These computer program instructions may be provided to a processor of a computer, such as one particularly configured to anatomy generation or simulation, or other programmable data processing apparatus to produce a machine, such that the instructions, which execute via the processor of the computer or other programmable data processing apparatus, create means for implementing the actions specified in the blocks of the flowcharts and block diagrams.

These computer program instructions may also be stored in a computer readable medium that can direct a computer, other programmable data processing apparatus, or other devices to function in a particular manner, such that the instructions stored in the computer readable medium produce an article of manufacture including instructions that implement the actions specified in the blocks of the flowcharts and block diagrams. The computer program instructions may also be loaded onto a computer, other programmable data processing apparatus, or other devices to cause a series of operational steps to be performed on the computer, other programmable apparatus, or other devices to produce a computer implemented process such that the instructions that execute on the computer or other programmable apparatus provide processes for implementing the actions specified in the blocks of the flowcharts and block diagrams.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this description are intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections.

It is contemplated that any part of any aspect or embodiment discussed in this specification can be implemented or combined with any part of any other aspect or embodiment discussed in this specification.

In construing the claims, it is to be understood that the use of computer equipment, such as a processor, to implement the embodiments described herein is essential at least where the presence or use of that computer equipment is positively recited in the claims.

One or more example embodiments have been described by way of illustration only. This description is been presented for purposes of illustration and description, but is not intended to be exhaustive or limited to the form disclosed. It will be apparent to persons skilled in the art that a number of variations and modifications can be made without departing from the scope of the claims.

1. A method for simulating deformation of a thin-shell material, the method comprising using a processor to:
(a) obtain a mesh of the material, wherein the mesh comprises polygons and hinges and wherein any two of the polygons that are adjacent to each other connect to each other at one of the hinges;
(b) determine forces affecting vertices of the mesh, wherein the forces comprise a gradient of cumulative potential energy comprising, for each of at least some of the hinges, a discretized bending energy that has a finite lower bound and that is determined using a difference between a current curvature vector and a reference curvature vector; and
(c) simulate deformation of the mesh using the forces affecting the vertices of the mesh.

2. The method of claim 1, wherein each of the current and reference curvature vectors vary quadratically with position of the vertices.

3. The method of claim 1, wherein the deformation is substantially isometric.

4. The method of claim 1, wherein the deformation is not substantially isometric.

5. The method of claim 1, wherein the discretized bending energy is determined from an even power of the difference between the current curvature vector and the reference curvature vector.

6. The method of claim 5, wherein the discretized bending energy is determined from a square of the difference between the current curvature vector and the reference curvature vector.

7. The method of claim 1, wherein the reference curvature vector comprises a reference curvature multiplied by a hinge normal vector, wherein the hinge normal vector comprises a weighted average of a first normal vector of a first polygon on one side of the hinge and a second normal vector of a second polygon defining on another side of the hinge.

8. The method of claim 7, wherein the polygons are triangles, using the processor to determine the first normal comprises determining a cross product of vectors corresponding to the hinge and another side of the first polygon, and using the processor to determine the second normal comprises determining a cross product of vectors corresponding to the hinge and another side of the second polygon, wherein the other sides of the first and second polygons share a vertex.

9. The method of claim 8, wherein the first normal vector is weighted by a first weight that varies inversely to an area of the first polygon, and the second normal vector is weighted by a second weight that varies inversely to an area of the second polygon.

10. The method of claim 9, wherein the first normal vector is weighted by a first weight comprising:
$$\frac{1}{{A}_{0} ‖ \frac{{n}_{0}}{{A}_{0}} + \frac{{n}_{1}}{{A}_{1}} ‖}$$
and the second normal vector is weighted by a second weight comprising:
$$\frac{1}{{A}_{1} ‖ \frac{{n}_{0}}{{A}_{0}} + \frac{{n}_{1}}{{A}_{1}} ‖}$$
wherein A₀ is an area of the first polygon, A₁ is an area of the second polygon, n₀ is the first normal, and n₁ is the second normal.

11. The method of claim 9, wherein each of the first and second weights is fixed at a value representing the first and second polygons when the mesh is in a rest configuration.

12. The method of claim 11, wherein the rest configuration is selected such that no hinge angle of any of the at least some of the hinges is 180 degrees.

13. The method of claim 11, wherein the hinge normal is determined as a⊗b, wherein
$$a = Xf , \\ b = Xg , \\ X = [ \begin{matrix}{x}_{0} & {x}_{1} & {x}_{2} & {x}_{3} \\ {x}_{0} & {x}_{1} & {x}_{2} & {x}_{3} \\ {x}_{0} & {x}_{1} & {x}_{2} & {x}_{3}\end{matrix} ] , \\ f = [ \begin{matrix}- 1 \\ 1 \\ 0 \\ 0\end{matrix} ] , \\ g = [ \begin{matrix}{w}_{1} - {w}_{0} \\ 0 \\ {w}_{0} \\ - {w}_{1}\end{matrix} ] ,$$
and
wherein x₀, x₁, and x₂ are the vertices of the first polygon; x₀, x₁, and x₃ are the vertices the second polygon; w₀ is the first weight; and w₁ is the second weight.

14. The method of claim 11, wherein the reference curvature vector is determined as a⊗b, wherein
a=Xf,
b=Xg, and
$$X = [ \begin{matrix}{x}_{0} & {x}_{1} & {x}_{2} & {x}_{3} \\ {x}_{0} & {x}_{1} & {x}_{2} & {x}_{3} \\ {x}_{0} & {x}_{1} & {x}_{2} & {x}_{3}\end{matrix} ] ,$$
and either:
$$f = [ \begin{matrix}- 1 \\ 1 \\ 0 \\ 0\end{matrix} ] and g = [ \begin{matrix}\overline{H} \cdot ( {w}_{1} - {w}_{0} ) \\ 0 \\ \overline{H} \cdot {w}_{0} \\ - \overline{H} \cdot {w}_{1}\end{matrix} ] , or$$
$$f = [ \begin{matrix}- \overline{H} \\ \overline{H} \\ 0 \\ 0\end{matrix} ] and g = [ \begin{matrix}( {w}_{1} - {w}_{0} ) \\ 0 \\ {w}_{0} \\ - {w}_{1}\end{matrix} ] ,$$
wherein x₀, x₁, and x₂ are the vertices of the first polygon; x₀, x₁, and x₃ are the vertices of the second polygon; w₀ is the first weight; w₁ is the second weight; and H̅ is the reference curvature.

15. The method of claim 13, wherein the current curvature vector is determined as Xl, wherein l is a 4×1 element Laplacian matrix determined using cotangent weights of the mesh in the rest configuration.

16. The method of claim 1, wherein the current curvature vector is a current mean curvature vector, and wherein the reference curvature vector is a reference mean curvature vector.

17. The method of claim 1, wherein the current curvature vector and the reference curvature vector are selected from the group consisting of mean curvature, anisotropic mean curvature, Gaussian curvature, maximum curvature, and minimum curvature.

18. The method of claim 1, further comprising using the processor to animate, on a display, the deformation of the mesh using results of simulating the deformation.

19. A system for simulating deformation of a thin-shell material, the system comprising:
(a) a display;
(b) an input device;
(c) a processor communicatively coupled to the display and input device; and
(d) a memory communicatively coupled to the processor, the memory having stored thereon computer program code, executable by the processor, which when executed by the processor causes the processor to perform a method comprising using the processor to:
(i) obtain a mesh of the material, wherein the mesh comprises polygons and hinges and wherein any two of the polygons that are adjacent to each other connect to each other at one of the hinges;
(ii) determine forces affecting vertices of the mesh, wherein the forces comprise a gradient of cumulative potential energy comprising, for each of at least some of the hinges, a discretized bending energy that has a finite lower bound and that is determined using a difference between a current curvature vector and a reference curvature vector; and
(iii) simulate deformation of the mesh using the forces affecting the vertices of the mesh.

20. A non-transitory computer readable medium having stored thereon computer program code, executable by a processor, which when executed by the processor causes the processor to perform a method comprising using the processor to:
(a) obtain a mesh of a thin-shell material, wherein the mesh comprises polygons and hinges and wherein any two of the polygons that are adjacent to each other connect to each other at one of the hinges;
(b) determine forces affecting vertices of the mesh, wherein the forces comprise a gradient of cumulative potential energy comprising, for each of at least some of the hinges, a discretized bending energy that has a finite lower bound and that is determined using a difference between a current curvature vector and a reference curvature vector; and
(c) simulate deformation of the mesh using the forces affecting the vertices of the mesh.
